(19) United States
(12) Patent Application Publication
(10) Pub. No.: US 2007/0273068 A1
(43) Pub. Date: Nov. 29, 2007

(54) Blow molding extrusion apparatus and method

(76) Inventors: John A. Ulcej, Colfax, WI (US); Dale P. Pitsch, Jim Falls, WI (US); Timothy C. Callahan, Chippewa Falls, WI (US)

Correspondence Address: MCCRACKEN & FRANK LLP, 200 W. ADAMS STREET, SUITE 2150, CHICAGO, IL, 60606, US

(21) Appl. No.: 11/706,491

(22) Filed: Feb. 15, 2007

Related U.S. Application Data
(63) Continuation-in-part of application No. 11/216,723, filed on Aug. 31, 2005.

(51) Int. Cl. B29C 47/06; B29C 49/00; B29C 45/00

(52) U.S. Cl. 264/514; 264/540; 425/532

(57) ABSTRACT

An apparatus for the extrusion a multi-layer parison comprises an extrusion blow molding head having a bore passing through the head with a diverter sleeve located within the bore. There is a first manifold in fluid communication with a first die inlet, the first manifold substantially surrounds the diverter sleeve and is in fluid communication with a proximal end of a flow path formed by the diverter sleeve and the bore; wherein the flow path extends from the proximal end to a head exit and a first land that has a variable width is positioned between the first manifold and the flow path. A second manifold is in fluid communication with a second die inlet, the second manifold substantially surrounds the diverter sleeve and is in fluid communication with the flow path at a first location downstream from the proximal end of the flow path; wherein the flow path has a width that increases at the first location; and a second land that has a variable width positioned between the second manifold and the flow path. The first manifold, the first land, the second manifold, and the second land are sized so that the flow of material through the flow path from proximal end to the head exit is substantially consistent to create a multi-layer flow of material to form the parison having a wall of a substantially similar cross section. The method includes introducing predefined volumes of polymer melt to the manifolds, passing the volume to the flow path and extruding the parison.

### CROSS REFERENCE TO RELATED APPLICATIONS

This application is a continuation-in-part of U.S. patent application Ser. No. 11/216,723 filed Aug. 31, 2005, and hereby incorporated by reference in its entirety.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

This invention relates to a head for the extrusion of blow molding parisons. More particularly this invention relates to a blow molding head for the extrusion of multi-layer parisons for use in blow molding bottles and other similar shapes.

2. Description of the Background of the Invention

Many bottles and other shapes that are blow molded require walls made of multiple layers for performance and/or cost reasons. For instance, in certain food contact packages, only certain grades of polymer are suitable for food contact. Often these food contact grades cost substantially more than other grades of similar materials, for instance material that includes a recycle stream. In this instance, the multiple layers will include an inner layer of food contact grade polymer, and an external layer of less expensive non-food contact grade polymer.

Often, there will also be a barrier layer within the multi-layer composite. Many polymers used for packaging are not sufficiently impermeable to oxygen, water vapor, carbon dioxide, etc. to be useful by themselves as a packaging material. Conversely, polymers with high barrier properties are often costly and sometimes these polymers do not possess proper physical properties to use in certain packaging environments.

In addition, in certain packaging environments, it may be desirable to include a light barrier sandwiched between two layers of a different color. In the dairy industry, light weight containers are often made from high density polyethylene. For appearance purposes, the external layers may be white, brown or some other color that indicates the type of dairy product contained in the package. However, it is also desirable to have a light transmission barrier sandwiched within the external color layers. Typically the light transmission barrier layer will be the same polymer that has been colored or pigmented with a black colorant.

To create a multiple layer bottle or similar structure, a pre-form or parison is first formed with the appropriate multiple layer structure. It is important that this parison be uniform so that when the bottle or other shape is formed from the parison, the resulting bottle or shape will also have the desired wall structure. For instance, it has been difficult in the past to create parisons for light weight containers with a black interior layer and produce a package without having any black show through the external color layer.

Multi-layered parisons are often formed using a continuous extrusion process where the extrusion head is fed by a series of extruders. These extruders force molten polymer material into the die head at a specific flow rate. The structure of the die head must be such that the resin transferred from the extruder to the die head is a laminar structure that exits the die head to form the multi-layered parison. Often the die head designs to accomplish this objective have been large and quite complicated. It is important that the sizing of the die head match the design of the parison and the extruders because residual polymer that remains within the die head can be degraded by the heat within the die head. After extrusion, the parison is often formed in line as the structure exits the blow molding head. Is has been particularly difficult to produce parisons that will be used to create thin walled multi-layered containers.

One problem with continuous extrusion equipment is the speed at which the parison can be created. Parison drop time is the time it takes to fully form the parison measured from the time the head begins to form the parison. If the drop time is too long for large multiple layer light weight container parisons made from low melt strength polymers, the weight of the molten parison during formation will be greater than the melt strength and the parison will fall to the floor before the parison can be fully formed. Reciprocating screw extruders can provide a faster drop time than a continuous extruder. However, it is much more difficult to balance the flow of multiple layers in a intermittent reciprocating screw extruder process than in a continuous extrusion process. One reason for this difficulty is that there is a start and a stop with each cycle of the reciprocating screw extruder. This creates a start up effect for each cycle that only occurs at initial start up for a continuous process. Because of the difficulty in properly balancing the flow multiple layers during this start up effect, it has not been possible to use reciprocating screw extruders to create multi-layered parisons that have a relatively uniform cross section.

### SUMMARY OF THE INVENTION

One embodiment of the present invention relates to an apparatus for the extrusion a multi-layer parison that includes an extrusion blow molding head having a bore passing through the head and a diverter sleeve located within the bore. A first manifold is provided in fluid communication with a first die inlet, where the first manifold substantially surrounds the diverter sleeve and is in fluid communication with a proximal end of a flow path formed by the diverter sleeve and the bore, wherein the flow path extends from the proximal end to a head exit, and a first land that has a variable width positioned between the first manifold and the flow path. In addition, there is a second manifold in fluid communication with a second die inlet, where the second manifold substantially surrounds the diverter sleeve and is in fluid communication with the flow path at a first location downstream from the proximal end of the flow path; wherein the flow path has a width that increases at the first location; and a second land positioned between the second manifold and the flow path, the second land having a variable width. The first manifold, the first land, the second manifold, and the second land are sized so that the flow of material through the flow path from the proximal end to the head exit is substantially consistent to create a multi-layer flow of material to form the parison having a wall of a substantially similar cross section.

A further embodiment of the present invention relates to a method of forming a multi-layer parison using extrusion blow molding that includes the steps of introducing a predefined volume of a first polymer melt into a first manifold that surrounds a flow path, wherein the first polymer melt is maintained in laminar flow, passing the predefined volume of the first polymer melt into the flow path, and simultaneously introducing a predefined volume of a second polymer melt into a second manifold that surrounds the flow path, wherein the second polymer melt is maintained in laminar flow. The method also includes the steps of passing the predefined volume of the second polymer melt into the flow path, combining the predefined volume of the first polymer melt with the predefined volume of the second polymer melt to form a multi-layer laminate in the flow path; and extruding the multi-layer laminate to form the parison.

A still further embodiment of the present invention relates to a method of forming a multi-layer parison using extrusion blow molding that includes the steps of introducing a predefined volume of a polymer melt into a manifold that surrounds a flow path, wherein the polymer melt is maintained in laminar flow and wherein the polymer melt comprises layers of different molten polymers, passing the predefined volume of the polymer melt into the flow path; and extruding the multi-layer laminate to form parison.

Other aspects and advantages of the present invention will become apparent upon consideration of the following detailed description, wherein similar structures have similar reference numerals.

### BRIEF DESCRIPTION OF THE DRAWINGS

FIG. 1 is a front top isometric view of one embodiment of a blow molding head assembly showing the mandrel adjustment assembly;

FIG. 2 is a back bottom isometric view of the embodiment of FIG. 1 showing the die adjustment assembly;

FIG. 3 is a cross-sectional view of a first embodiment of the assembly of FIG. 1 taken generally along lines 3-3 of FIG. 1;

FIG. 4 is a plan view of the bottom of the upper plate of the assembly of FIG. 3;

FIG. 5 is a plan view of the top of the upper mid plate of the assembly of FIG. 3;

FIG. 6 is a sectional view taken generally along the line 6-6 in FIG.4;

FIG. 7 is a sectional view taken generally along the line 7-7 in FIG. 5;

FIG. 8 is a cross-sectional view of a second embodiment of the assembly of FIG. 1 taken generally along the lines 8-8 of FIG. 1;

FIG. 9 is a plan view of the bottom of the upper mid plate of the assembly of FIG. 8;

FIG. 10 is an enlarged bottom trimetric view of the upper mid plate of FIG. 8;

FIG. 11 is a plan view of the top of the lower mid plate of the assembly of FIG. 8;

FIG. 12 is an enlarged fragmentary view of laminar flow between upper and lower mid plates of the assembly of FIG. 8;

FIG. 13 is a schematic cross section of a portion of a parison wall extruded by the assembly of FIG. 1;

FIG. 14 is a schematic cross section of a portion of a further embodiment of a parison wall extruded by the assembly of FIG. 1; and

FIG. 15 is a schematic view showing a die head with three extruders.

### DETAILED DESCRIPTION OF THE PREFERRED EMBODIMENTS

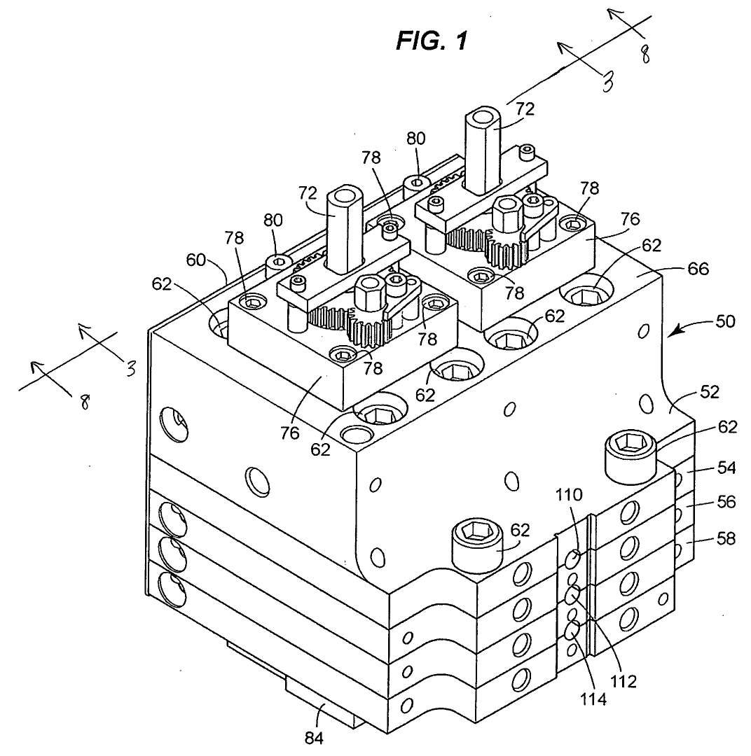

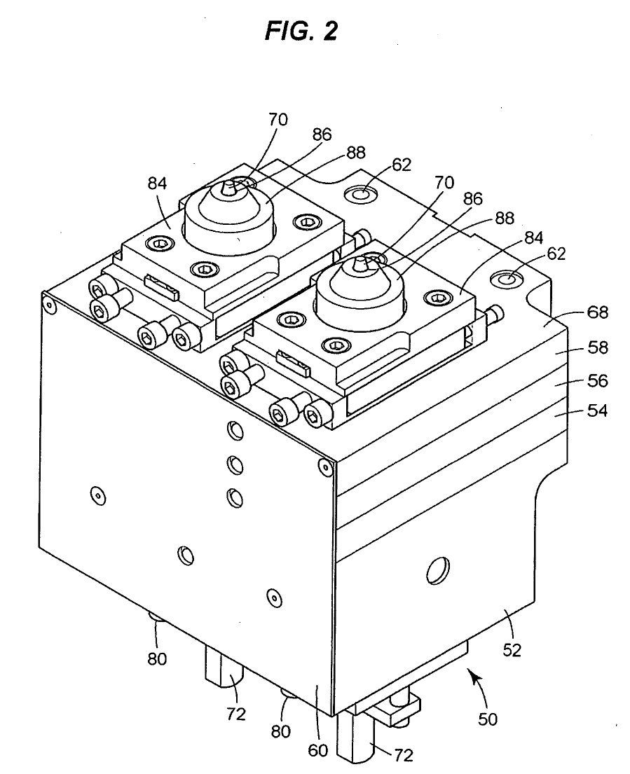

FIGS. 1 and 2 depict a blow molding head 50. The blow molding head 50 simultaneously will produce two different parisons. Any number of parallel streams can be included within the design of the present invention. One advantage of the blow molding head 50 as shown is the compact design that allows for more blow molding streams to be combined in a small space. Parisons for packages are often formed in arrays of molds, such as a twelve up mold on three and a half to four inch centers. The compact design of the die head 50 allows multiple die heads to be placed in close proximity to produce multiple parisons in an efficient manner. Prior conventional die heads could not be used in such close proximity to feed molds that are even on four inch centers.

The blow molding head 50 can be fabricated using a number of conventional techniques from standard materials such as various grades of stainless steel, and other steels. However, it is preferred to fabricate the blow molding head 50 using a split body design as shown in FIGS. 1 and 2. The split body design enables the designer to precisely create desired flow channels to achieve an optimum result. For instance, the flow channels can be directly machined to enable the laminar flow of multiple layer polymer melts through the blow molding head 50.

The blow molding head 50 as shown in FIGS. 1 and 2 is capable of combining streams from three different sources (not shown) and includes a top plate 52, an upper mid plate 54, a lower mid plate 56, and a bottom plate 58. A cover plate 60 covers the entire back surface of the blow molding head 50 to protect internal heater wires and other conventional internal elements. The upper plate 52, the upper mid plate 54, the lower mid plate 56, and the bottom plate 58 are held together in a conventional manner by a series of body bolts 62.

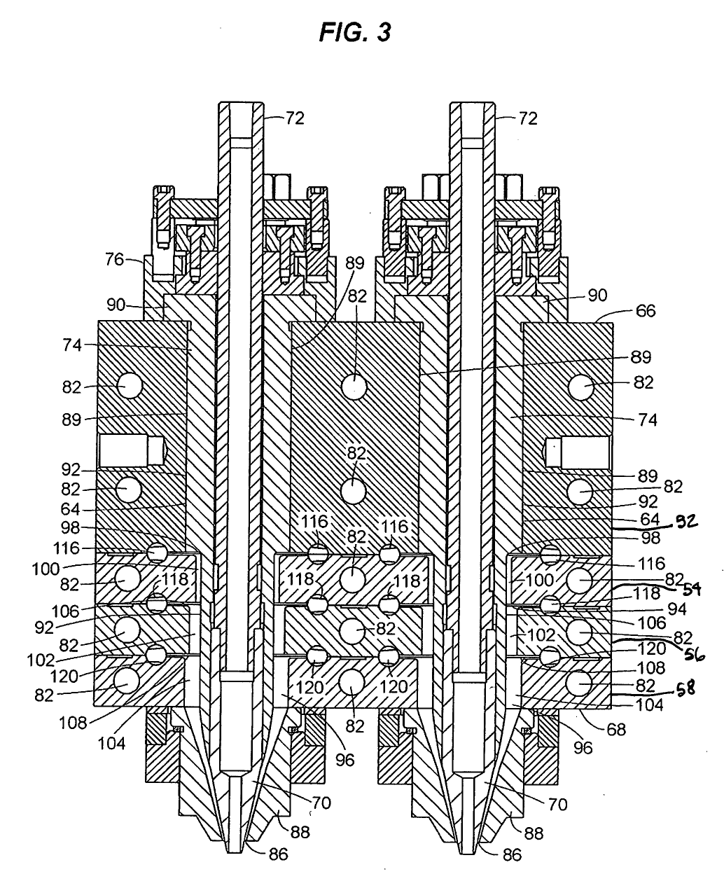

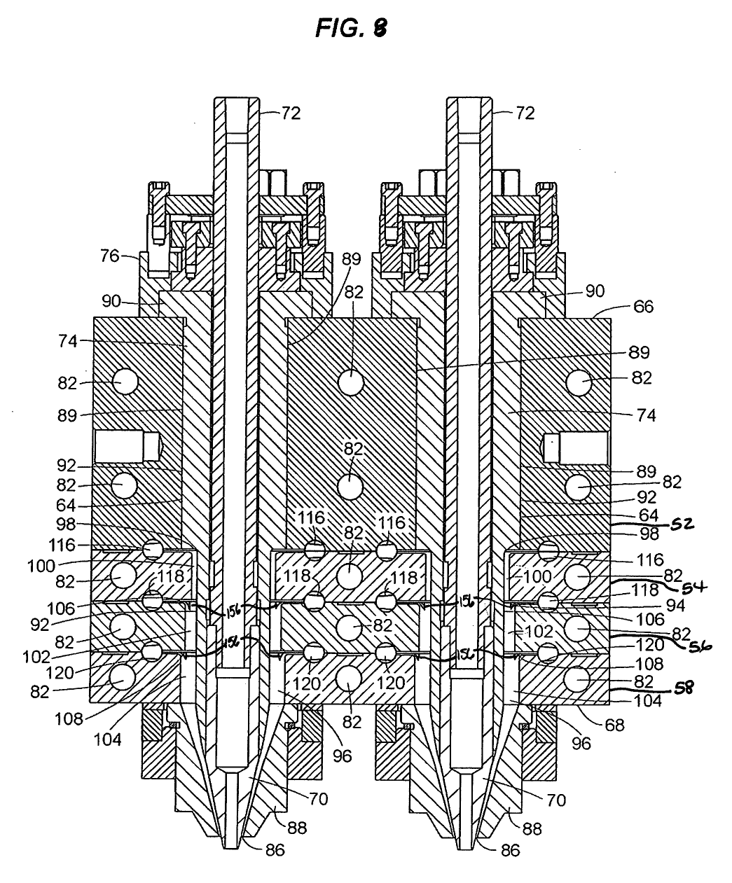

FIGS. 3-7 show a first embodiment of the bottom portions of the upper plate 52, upper mid plate 54, and the lower mid plate 56 and top portions of the upper mid plate 54, lower mid plate 56, and the bottom plate 58. FIGS. 8-11 show a second embodiment of bottom portions of the upper mid plate 54 and the lower mid plate 56 and top portions of the lower mid plate 56 and the bottom plate 58.

The blow molding head 50 has two cylindrical bores 64 passing from a top surface 66 of the upper plate 52 to a bottom surface 68 of the lower plate 58. A mandrel 70, a mandrel extension 72, and a diverter sleeve 74 are placed within each bore 64 as shown in FIGS. 3 and 8. The mandrel 70, the mandrel extension 72, and the diverter sleeve 74 are held in place by a mandrel adjustment assembly 76. The mandrel adjustment assembly 76 is a conventional design well known to those in the industry and will not be further discussed except to note that the mandrel adjustment assembly 76 is fastened to the top surface 66 of the top plate 52 by a series of bolts 78 and the mandrel adjustment assembly 76 is capable of adjusting the position of the mandrel 70 in a conventional fashion. In addition to the body bolts 62, a series of jack bolts 80 and dowel pins (not shown) are included to assist with the assembly and maintenance of the blow molding head 50. In addition, a series of cartridge heaters 82 are placed within the blow molding head 50 to provide heat to maintain the polymers in a molten state.

Attached to the bottom surface 68 of the bottom plate 58 is a conventional die adjustment assembly 84 that along with the mandrel adjustment assembly 76 is capable of adjusting the size and shape of a head exit 86 formed between the mandrel 70 and a die bushing 88. The die bushing 88 is held in place by the die adjustment assembly 84.

The bore 64 passes through the upper plate 52, the upper mid plate 54, the lower mid plate 56, and the bottom plate 58 and has a varying diameter from the top surface 66 to the bottom surface 68 with a smooth surface 89 that will permit the molten polymer to flow with a minimum of sidewall resistance. The diverter sleeve 74 has a flange 90 that is held against the top surface 66 by the mandrel adjustment assembly 76. The flange 90 and a first section 92 form a fluid seal with the surface 89 of the bore 64 to prevent the flow of molten polymer within the first section 92. The first section 92 extends from the flange 90 to the beginning of a second section 94 that has a diameter less than the diameter of the bore 64 and less than the first section 92. The second section 94 and the surface 89 of the bore 64 form a flow channel 96. The flow channel 96 extends from a proximal end 98 to the head exit 86. In the embodiment shown in FIG. 3, the flow channel 96 has three separate regions 100, 102, and 104. The first region 100 extends from the proximal end 98 to a first location 106 and the second region 102 extends from the first location 106 to a second location 108. The second region 102 of the flow channel 96 is wider than the first region 100 to accommodate the flow of multiple streams of polymer melt, as will be further discussed hereinafter. In a similar manner, the third region 104 is wider than the second region 102. The relative width of the first, second and third regions 100, 102 and 104 should be chosen so that the polymer melt will flow in a laminar fashion as the polymer streams are joined at the first location 106 and the second location 108 and flow through the second and third regions 102 and 104 to the head exit 86.

The blow molding head 50 also has three polymer melt inlets 110, 112, and 114. Each of the polymer melt inlets 110, 112, and 114 are capable of being place in fluid communication with an extruder. Sometimes an adapter is used to facilitate this communication. As noted above, the extruder to be used with the blow molding head 50 can be either continuous or intermittent. For many blow molding applications, a reciprocating screw extruder can be used. Each of the polymer melt inlets is connected to a respective manifold 116, 118 and 120. Each molten polymer used to form the parison is introduced into the blow molding head 50 through one of the inlets 110, 112, or 114. The manifold 116 is in fluid communication with the flow channel 96 at the proximal end 98 of the flow channel 96. In a similar manner, the manifold 118 is in fluid communication with the flow channel 96 at the first location 106 and the manifold 120 is in fluid communication with the flow channel 96 at the second location 108. In a preferred embodiment, each manifold is located on a plane with its respective die inlet that is perpendicular to a direction of flow of the flow path 96. This arrangement adds to the compact nature of the blow molding head 50 and simplifies the manufacture of the blow molding head 50 and the control of the flow of polymer melt through the blow molding head 50.

The length of the first, second and third regions 100, 102, and 104 can be relatively short because of the design of the blow molding head 50. It is important to minimize the length of these sections so that the residence time of the polymer melt within the blow molding head 50 is minimized. In one embodiment, the manifolds 116, 118, and 120 also should be sized so that each manifold is substantially emptied of polymer as each parison or series of parisons is made on a first in, first out basis. Alternatively, the manifolds 116, 118, and 120 can be sized so that the manifolds 116, 118, and 120 contain enough polymer to form multiple parisons. Any size of manifold can be used relative to the size of the parison so long as the polymer does not remain within the blow molding head 50 for any significant length of time. This will minimize heat degradation of the polymer and enable the manufacturer to use polymers that are somewhat heat sensitive in the manufacture of parisons.

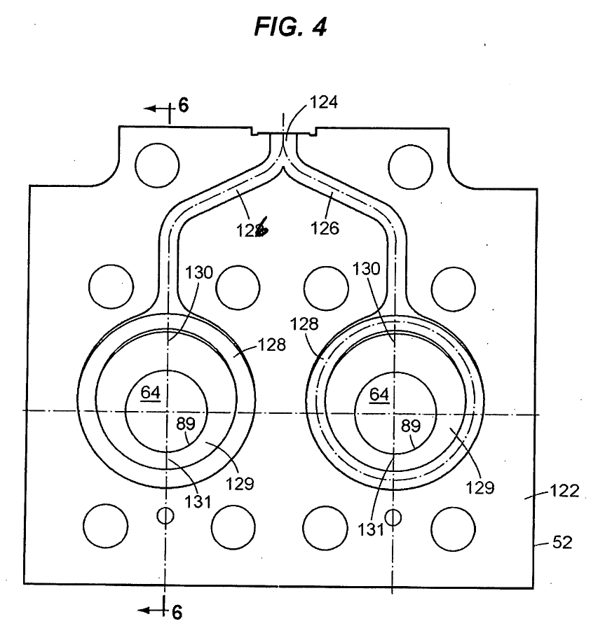

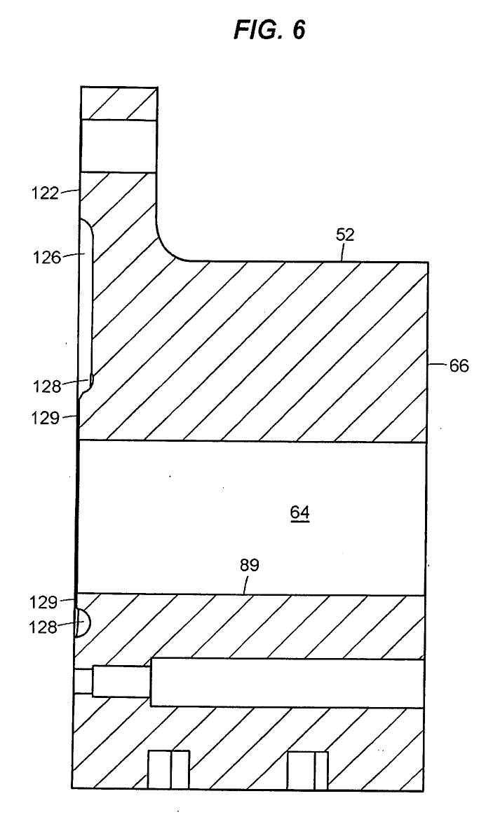

Because the construction of each of the manifolds 116, 118 and 120 are similar, only manifold 116 will be described in detail. Although there may be minimal differences among the manifolds, lands and flow channels to accommodate the flow characteristics of various polymer melts, each of manifolds 118 and 120 will be substantially similar to the manifold 116. Referring to the first embodiment of FIGS. 4 and 6, a bottom surface 122 includes an inlet channel 124, two distribution channels 126 and two top portions 128 of the manifold 116. Each top portion 128 encircles the bore 64. Between the bore 64 and the top portion of the manifold 128 is a land 129. The land 129 has a variable width, being wider at a point 130 where the distribution channel 126 joins the top portion 128 and becoming progressively narrower until the land 129 is narrowest at a point 131 diametrically opposite to the location of the point 130. The shape of the land 129 assists in directing the flow of the polymer melt around the entire circumference of the manifold 116 to properly fill the manifold 116 and form a laminar flow of polymer melt that is consistent throughout the entire circumference of the flow channel 96.

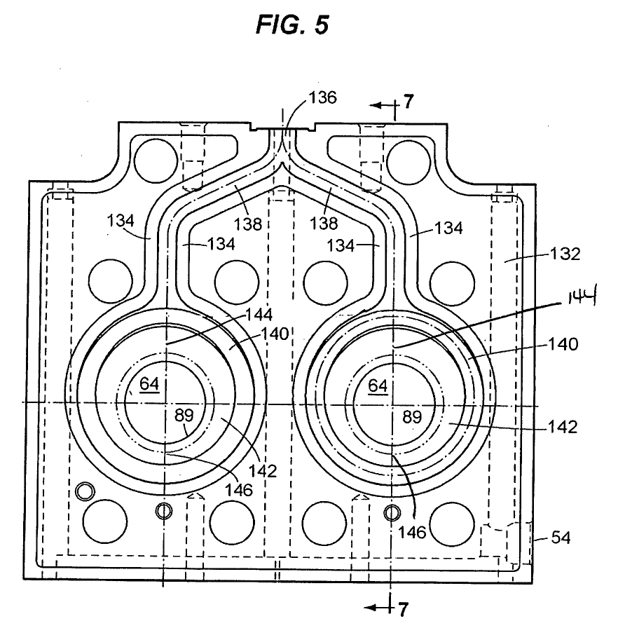

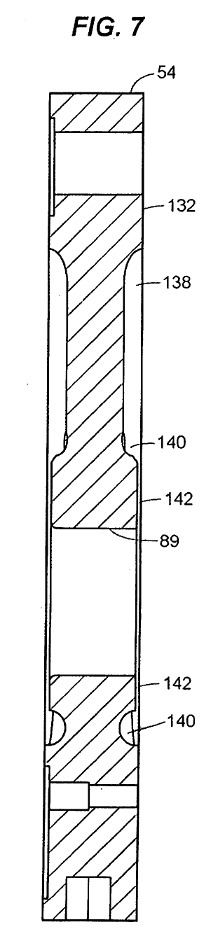

Referring to FIGS. 5 and 7, in a first embodiment, a top surface 132 of the upper mid plate 54 includes metal seal surface 134. When the upper plate 52 is fastened to the upper mid plate 54, the bottom surface 122 of the upper plate 52 contacts the metal seal surface 134 to form a metal to metal seal. An inlet channel 136 is formed in the top surface 132 within the metal seal surface 134. Two distribution channels 138 are in fluid communication with the inlet channel 136. Also, two bottom portions 140 of the manifold 116 are formed in the top surface 132. The two bottom portions 140 also encircle the bore 64. Lastly, a land 142 is provided between each bottom portion 140 and its respective bore 64. The land 142 is shaped in a similar manner to the land 129 and is wider at a point 144 where the distribution channel 138 joins the bottom portion 140 and becomes progressively narrower until the narrowest point is reached at a point 146 diametrically opposite the point 144. The land 142 cooperates with the land 129 described above to assist in regulating the flow of the polymer melt within the blow molding head 50.

When the upper plate 52 is joined to the upper mid plate 54, the inlet channel 124 and the inlet channel 136 form the polymer melt inlet 110, the top and bottom portions 128 and 140 form the manifold 116 and the distribution channels 126 and 138 form a distribution conduit connecting the polymer melt inlet 110 with the manifold 116. As noted above, the lands 129 and 142 control the flow of molten polymer as it passes from the manifold 116 into the flow channel 96 formed by the diverter sleeve 74 and the surface 89. The volume of the polymer melt inlet 110, the distribution conduit, the manifold 116, and the space between the lands 129 and 142 should be kept small enough so that as each parison is formed the polymer melt in this collective volume is replaced by fresh polymer melt material on a first in, first out basis. In a preferred embodiment, the combined volumes of the polymer melt inlet 110, the distribution conduit, the manifold 116, the space between the lands 129 and 142, and the first, second and third regions 100, 102 and 104 should be completely replaced by fresh polymer melt as each parison or group of parisons are manufactured. In this way, there is a minimum of residual polymer melt that will remain within the blow molding head 50 between each cycle. Also, in the embodiment as described, the manifold 116 and the polymer melt inlet 110 are all essentially on the same plane that is perpendicular to the direction of the bore 64. This assists in keeping the blow molding head 50 compact so that long flow channels are avoided and so that multiple heads can be combined to create multiple parisons in a compact space.

The relatively high rheology of the polymer melt and the relatively small volumes and distance the polymer melt must travel will all assist in maintaining laminar flow throughout the blow molding head. This is important because the presence of any turbulence or eddy flows will disturb the interface between adjacent layers in the polymer melts. As noted above, the flow channel 96 is formed to assist in maintaining laminar flow by increasing in volume as the flow channel 96 progresses past the first location 106 to the second location 108 and on to the head exit 86.

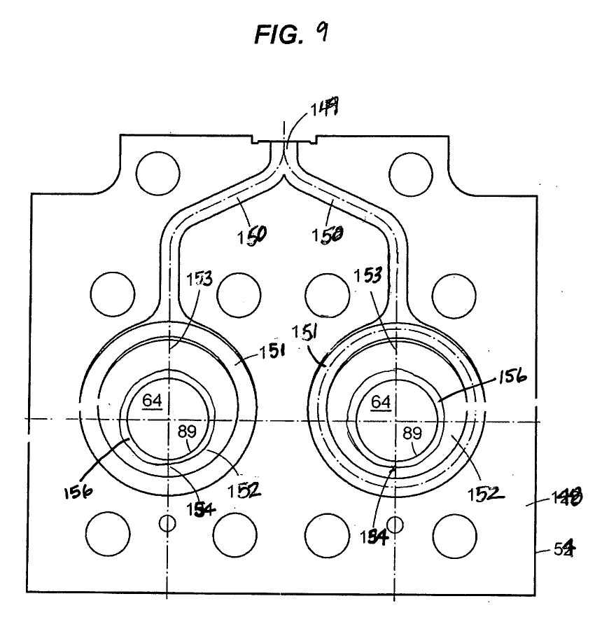

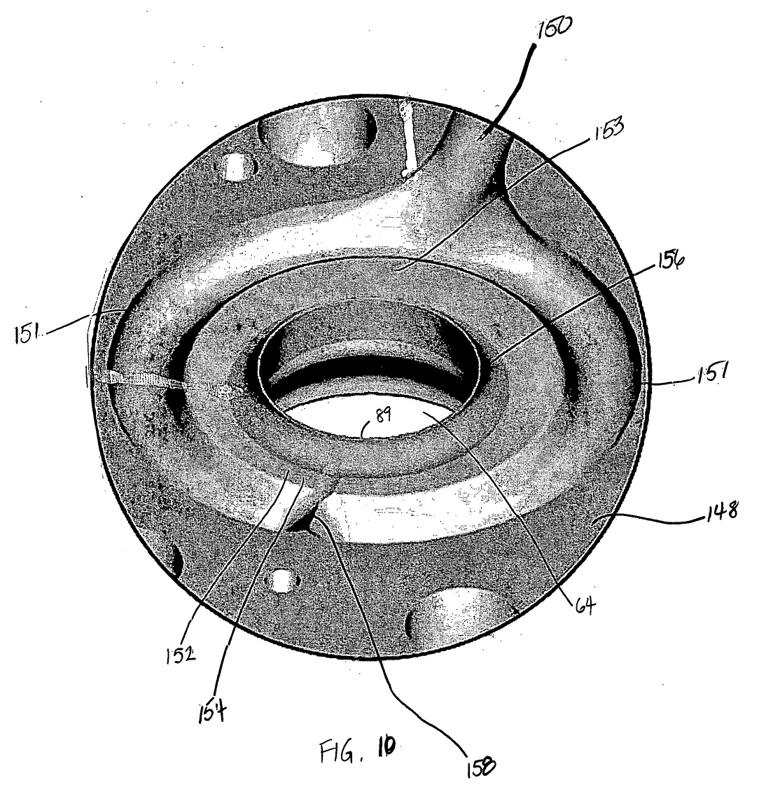

FIGS. 8-11 depict a second embodiment of a bottom surface 148 of the upper mid plate 54 and a top surface of the lower mid plate 56, it being understood that a bottom surface of the lower mid plate 56 is identical to the bottom surface of the upper mid plate 54 and a top surface of the bottom plate 58 is identical to the top surface of the lower mid plate 56. Referring to the FIGS. 9 and 10, a bottom surface 148 of the upper mid plate 54 includes an inlet channel 149, two distribution channels 150 and two top portions 151 of the manifold 118. Each top portion 151 encircles the bore 64. Between the bore 64 and the top portion 151 of the manifold 118 is a land 152. The land 152 has a variable width, being wider at a point 153 where the distribution channel 150 joins the top portion 151 and becoming progressively narrower until the land 152 is narrowest at a point 154 diametrically opposite to the location of the point 153. The shape of the land 152 assists in directing the flow of the polymer melt around the entire circumference of the manifold 118 to properly fill the manifold 118 and form a laminar flow of polymer melt that is consistent throughout the entire circumference of the flow channel 96. In addition, a flow diverter 156 in the form of a ring is disposed between each land 152 and each bore 64 to further aid in influencing the direction and flow of polymer melt such that the melt is parallel to the laminar flow of the other polymer melts within the blow molding head 50 when the melts are combined. The flower diverter 156 may be a flange or lip having a gradual slope that turns away from the land 152 at an angle of about 90 degrees, although any angle up to 90 degrees would be sufficient, such that a polymer melt flowing through the inlet channel 149 to the distribution channels 150 is turned before touching other melt, thereby causing the polymer melt to become parallel with the other melt and prevent disruption in the flow of melt and the creation of a multi-layer parison. Optionally, the flow diverter 156 may have a sharp slope. Also optionally, the flower diverter 156 could be a separate from or integral with the respective plate 54, 56, 68.

Referring to FIG. 10, a divot 158 may be created where the two top portions 151 of the manifold 118 combine. A weld line, which is an area of thinner material, can form at an area where the top portions 151 combine. The divot 158 is an upwardly projecting ridge that prevents weld lines from forming in extruded materials. In particular, the divot 158 adds extra material to the area where material from the top portions 151 combine.

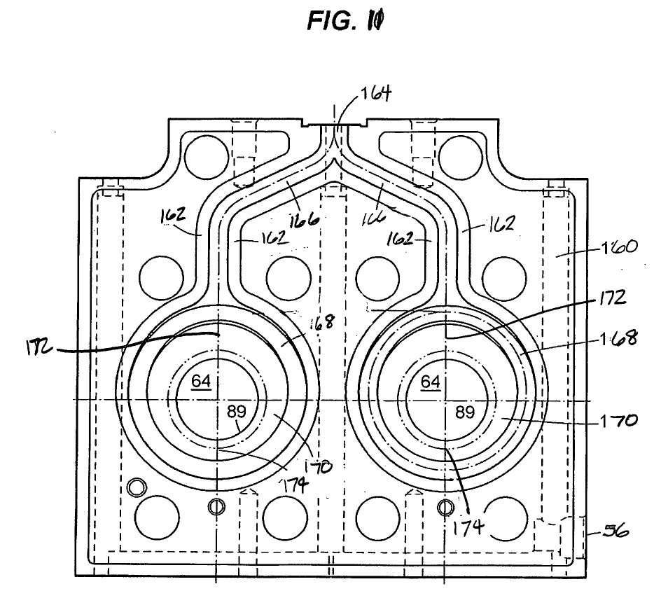

Referring to FIG. 11, a top surface 160 of the lower mid plate 56 includes a metal seal surface 162. When the upper mid plate 54 is fastened to the lower mid plate 56, the bottom surface of the upper mid plate 54 contacts the metal seal surface 162 to form a metal to metal seal. An inlet channel 164 is formed in the top surface 160 within the metal seal surface 162 and two distribution channels 166 are in fluid communication with the inlet channel 164. Bottom portions 168 of the manifold 118 are formed in the top surface 160 and further encircle the bore 64. A land 170 is provided inwardly from and adjacent each bottom portion 168. Each land 170 is shaped in a similar manner to the lands 129, 142 and is wider at a point 172 where the distribution channel 166 joins the bottom portion 168 and becomes progressively narrow until the narrowest point is reach at a point 174 diametrically opposite the point 172. The land 152 cooperates with the land 170 to aid in regulating the flow of polymer melt within the blow molding head 50.

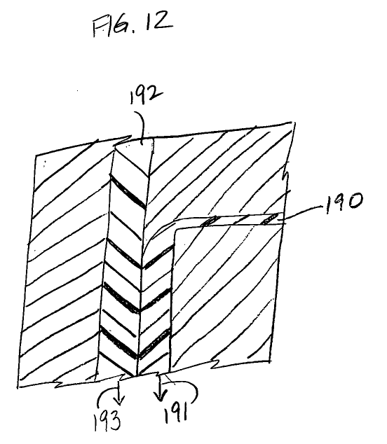

When the upper mid plate 54 is joined to the lower mid plate 56, the inlet channel 149 and the inlet channel 164 form the polymer melt inlet 110, the top and bottom portions 151 and 168 form the manifold 118 and the distribution channels 150 and 166 form a distribution conduit connecting the polymer melt inlet 110 with the manifold 118. As noted above, the lands 152 and 170 control the flow of molten polymer as it passes from the manifold 118 into the flow channel 96 formed by the diverter sleeve 74 and the surface 89. The volume of the polymer melt inlet 110, the distribution conduit, the manifold 118, and the space between the lands 152 and 170 should be kept small enough so that as each parison is formed the polymer melt in this collective volume is replaced by fresh polymer melt material on a first in, first out basis. In a preferred embodiment, the combined volumes of the polymer melt inlet 110, the distribution conduit, the manifold 118, the space between the lands 152 and 170, and the first, second, and third regions 100, 102 and 104 should be completely replaced by fresh polymer melt as each parison or group of parisons are manufactured. In this way, there is a minimum of residual polymer melt that will remain within the blow molding head 50 between each cycle. Also, in the embodiment as described, the manifold 118 and the polymer melt inlet 110 are all essentially on the same plane that is perpendicular to the direction of the bore 64. This assists in keeping the blow molding head 50 compact so that long flow channels are avoided and so that multiple heads can be combined to create multiple parisons in a compact space. FIG. 12 depicts the laminar flow of a first melt 190 flowing in a direction indicated by a first arrow 191 through the manifold 118 and combining with a second melt 192 flowing in a direction indicated by a second arrow 193, wherein the first melt 190 is parallel to the second melt 192 when the two melts 190, 192 combine.

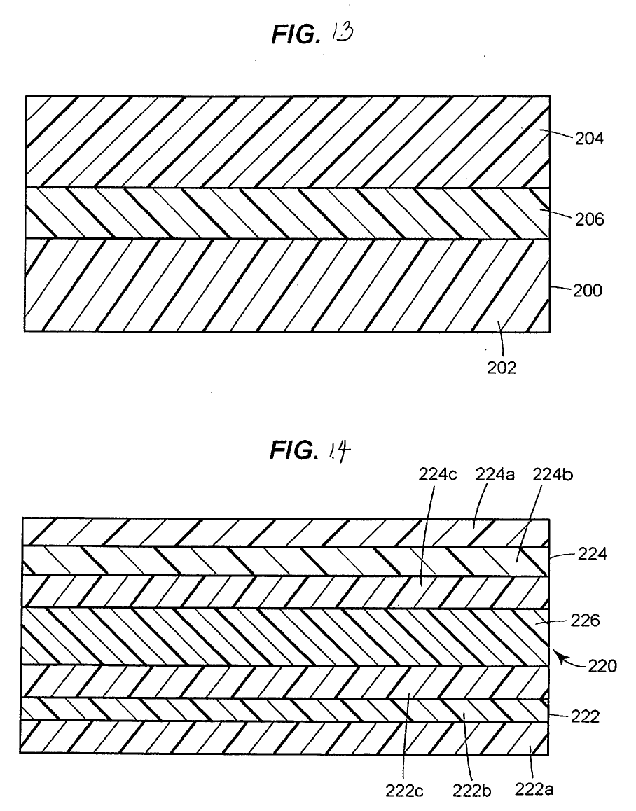

FIG. 13 shows a schematic cross section of a parison wall 200 formed by the apparatus and method of the present invention. The parison wall 200 has an inner layer 202. Typically, this layer will be a relatively inexpensive polymer material with the desired mechanical properties for the object to be molded. For instance where the object is a bottle, the inner layer 202 can be polyethylene, polypropylene, polyethylene terephthalate (PET), and the like, including mixtures, that have dimensional strength, impact resistance and the like. Also, where the inner layer 202 is to be in contact with food, the polymer will also be food contact grade. The parison also will have an outer layer 204. In some embodiments, the outer layer 204 can be the same material as the inner layer 202. In other embodiments, the inner layer and the outer layer 204 can be formed from different materials. For instance, where it is necessary to use food contact grade material as the inner layer, because these materials are often relatively expensive, it may be desirable to use a similar non-food contact polymer as the outer layer 204. For instance, the inner layer could be virgin food contact PET and the outer layer could be less expensive recycled PET. The middle layer 206 is often added to enhance some property of the resulting wall. For instance, PET is not a good barrier for carbon dioxide. In this case, a compatible carbon dioxide barrier material such as ethylene vinyl alcohol (EVOH), nylon and mixtures of EVOH and nylon will be used as the middle layer 206.

In another embodiment, the parison wall 200 can be formed from three layers of the same polymer that differ only in color. As noted previously, in certain industries it may be desirable to include a light blocking layer in a package wall while at the same time have an exterior wall color that is lighter in color. In the dairy industry, milk bottles often are white or if they are colored, the color matches a flavor, such as brown for chocolate milk. For a milk container, the inner layer 202 can be a high density polyethylene that is pigmented with a white pigment. Typically, the outer layer 204 will also be pigmented white in the same fashion. Because light can degrade milk, it is desirable to use a middle layer 206 of the same high density polyethylene that is colored with a black pigment or dye. In place of the black color other dark colors can be used but black pigments are inexpensive and very effective at blocking light. For certain low cost packages, it may be desirable only to use two layers, outer layer 204 and middle layer 206. In this case the outer layer 206 will be colored white or some other color and the middle layer 206 will be colored black. Also, there may be situations where it is desired to have a different color for the inner layer 202 than the outer layer 206. Because the die head 50 and the embodiments of the method of the present invention can produce parisons that are substantially uniform, the resulting packages will appear to the end user as if they are colored with the exterior color and the middle layer 206 color will not bleed through the outer layer 204.

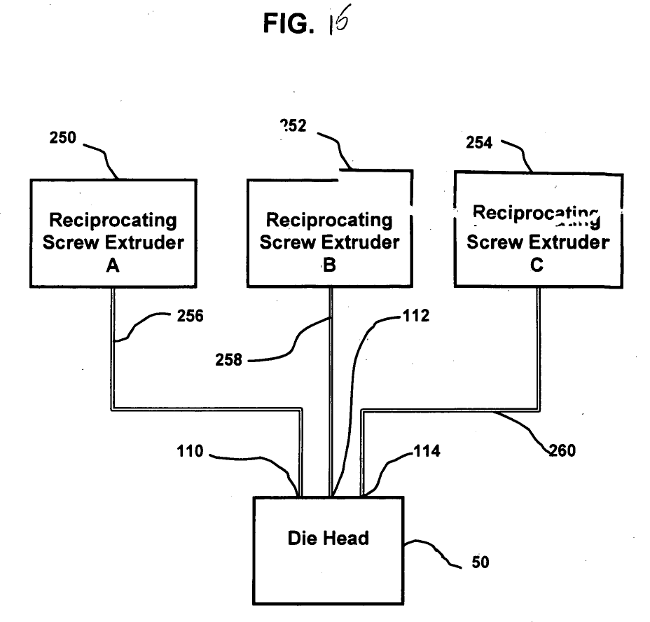

FIG. 14 shows a wall 220 both outer layers 222 and 224 are formed from multi-layer materials 222a, 222b, 222c, 224a, 224b, and 224c. Where it is desirable to enhance the barrier and/or other properties of the resulting shape or bottle, multiple polymers may be desirable. Because the flow through the blow molding head 50 is laminar and can be closely controlled, it is possible to introduce into one, some or all the polymer melt inlets 110, 112, and 114 as a pre-existing laminar material. In this case the layers of the pre-existing material are substantially maintained in tact as the layers flow through the blow molding head 50 to form the parison. Even though the middle layer 226 is shown as a single layer material, this middle layer could also be formed from a multi-layered material if desired.

With reference to FIG. 15, the blow molding head 50 is shown in a schematic side view. Three reciprocating screw extruders 250, 252, and 254 are each in respective fluid communication with die inlets 110, 112, and 114 through pipes 256, 258 and 260. Each of the reciprocating screw extruders 250, 252, and 254 is set up so that a premises amount of polymer melt flows into the die head 50 through the respective die inlets 110, 112, and 114. Depending upon the desired structure of the parison to be produced, fewer or more reciprocating screw extruders can be used. Also, the modular nature of the die head 50 will enable the die head to be modified to work with the appropriate number of extruders.

The blow molding head 50 of the present invention has been described with regard to an embodiment that combines three polymer streams into a single parison structure. The modular nature of the blow molding head 50 enable this blow molding head 50 to be structured to combine two, three, four or more separate polymer inlet streams into a single product. In addition, because of the unique nature of the blow molding head 50, it is also possible to use a single inlet polymer stream that itself includes multiple layers of polymer material and pass this single stream through a blow molding head that has a single manifold that encircles the central bore to form a multi-layer parison.

### INDUSTRIAL APPLICABILITY

This die head and method are useful for producing multi layered parisons used to produce thin walled packages and containers.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. An apparatus for the extrusion a multi-layer parison comprising:
an extrusion blow molding head having a bore passing through the head;
a diverter sleeve located within the bore;
a first manifold in fluid communication with a first die inlet, the first manifold substantially surrounding the diverter sleeve and in fluid communication with a proximal end of a flow path formed by the diverter sleeve and the bore; wherein the flow path extends from the proximal end to a head exit;
a first land that has a variable width positioned between the first manifold and the flow path;
a second manifold in fluid communication with a second die inlet, the second manifold substantially surrounding the diverter sleeve and in fluid communication with the flow path at a first location downstream from the proximal end of the flow path; wherein the flow path has a width that increases at the first location; and
a second land that has a variable width positioned between the second manifold and the flow path;
wherein the first manifold, the first land, the second manifold, and the second land are sized so that the flow of material through the flow path from proximal end to the head exit is substantially consistent to create a multi-layer flow of material to form the parison having a wall of a substantially similar cross section.

2. The apparatus of claim 1 that further includes a third manifold in fluid communication with a third die inlet, the third manifold substantially surrounding the diverter sleeve, the third manifold in fluid communication with the flow path and entering the flow path at a second location downstream from the first location; the flow path having a width that increases at the second location; and a third land positioned between the third manifold and the flow path, the third land having a variable width.

3. The apparatus of claim 1 wherein the flow path, the first manifold, and the second manifold have a volume no greater than the volume of the material needed to form the parison.

4. The apparatus of claim 1 wherein the extrusion blow molding head is formed from multiple separately formed plates that are combined to form the head.

5. The apparatus of claim 1 wherein each manifold and the respective die inlet are located on a plane that is substantially perpendicular to a direction of the flow path.

6. The apparatus of claim 1 wherein the width of the first and second lands decreases from a point where the material enters the manifold to a point diametrically opposite the first point.

7. The apparatus of claim 1 further including a first flow diverter disposed between the first manifold and the flow path to lessen disruption in the flow of melt during the creation of the multi-layer parison.

8. The apparatus of claim 7 further including a second flow diverter disposed between the second manifold and the flow path to lessen disruption in the flow of melt during the creation of the multi-layer parison.

9. The apparatus of claim 8 wherein the first and second flow diverters are each disposed at an angle of about 90 degrees with respect to the first and second lands, respectively.

10. A method of forming a multi-layer parison using extrusion blow molding that comprises the steps of:
introducing a predefined volume of a first polymer melt into a first manifold that surrounds a flow path, wherein the first polymer melt is maintained in laminar flow;
passing the predefined volume of the first polymer into the flow path;
simultaneously introducing a predefined volume of a second polymer melt into a second manifold that surrounds the flow path, wherein the second polymer melt is maintained in laminar flow;
passing the predefined volume of the second polymer melt into the flow path;
combining the predefined volume of the first polymer melt with the predefined volume of the second polymer melt to form a multi-layer laminate in the flow path; and
extruding the multi-layer laminate to form the parison.

11. The method of claim 10 that includes the steps of introducing a predefined volume of a third polymer melt into a third manifold that surrounds the flow path, wherein the third polymer melt is maintained in laminar flow; passing the predefined volume of the third polymer into the flow path and combining the predefined volume of the third polymer melt with the predefined volume of the first polymer melt and the predefined volume of the second polymer melt to form the multi-layer laminate in the flow path.

12. The method of claim 11 wherein the first polymer melt and the third polymer melt are the same.

13. The method of claim 11 wherein the first polymer melt and the third polymer melt are different.

14. The method of claim 10 wherein the first polymer melt comprises multiple layers of molten polymer in laminar flow.

15. The method of claim 10 wherein the second polymer melt is a barrier polymer.

16. The method of claim 10 wherein the first polymer is selected from the group consisting of polyethylene, polypropylene, polyethylene terephthalate, and mixtures thereof.

17. The method of claim 15 wherein the second polymer is selected from the group consisting of ethylene vinyl alcohol, nylon, and mixtures thereof.

18. The method of claim 10 wherein the first polymer melt and the second polymer melt are different colors.

19. The method of claim 11 wherein the first polymer melt and the second polymer melt are different colors and wherein the third polymer melt is a different color than color of the second polymer melt.

20. The method of claim 19 wherein the first polymer melt and the third polymer melt are the same color.

21. The method of claim 10 wherein the predefined volume of the first polymer melt is created using a reciprocating screw extruder.

22. The method of claim 21 wherein the predefined volume of the second polymer melt is created using a second reciprocating screw extruder.

23. The method of claim 10 wherein the passing steps include passing the predefined volumes of the first and second polymers over flow diverters into the flow path.

24. The method of claim 23 wherein the flow diverters are disposed at an angle of about 90 degrees with respect to first and second land portions of the first and second manifolds, respectively.

25. A method of forming a multi-layer parison using extrusion blow molding that comprises the steps of:
introducing a predefined volume of a polymer melt into a manifold that surrounds a flow path, wherein the polymer melt is maintained in laminar flow and wherein the polymer melt comprises layers of different molten polymers;
passing the predefined volume of the polymer melt into the flow path; and
extruding the multi-layer laminate to form parison.

26. The method of claim 25 wherein one of the different molten polymers is a barrier polymer.

27. The method of claim 25 wherein one of different molten polymers is selected from the group consisting of polyethylene, polypropylene, polyethylene terephthalate and mixtures thereof.

28. The method of claim 26 wherein one of different molten polymers is selected from the group consisting of ethylene vinyl alcohol, nylon, and mixtures thereof.

29. The method of claim 25 wherein the passing step includes passing the predefined volume of the polymer melt over a flow diverter into the flow path.

30. The method of claim 29 wherein the flow diverters are disposed at an angle of about 90 degrees with respect to a land portion of the manifold.
